(19) United States
(12) Patent Application Publication
(10) Pub. No.: US 2020/0034073 A1
(43) Pub. Date: Jan. 30, 2020

(54) ACCELERATING BACKGROUND TASKS IN A COMPUTING CLUSTER

(71) Applicant: Nutanix, Inc., San Jose, CA (US)

(72) Inventors: Arun SAHA, Fremont, CA (US); Varun Kumar ARORA, Mountain View, CA (US); Vinayak Hindurao KHOT, Sunnyvale, CA (US)

(21) Appl. No.: 15/162,514

(22) Filed: May 23, 2016

Related U.S. Application Data
(60) Provisional application No. 62/298,207, filed on Feb. 22, 2016.

(51) Int. Cl. G06F 3/06

(52) U.S. Cl. CPC G06F 3/0659; G06F 3/067; G06F 3/0611

(57) ABSTRACT

Systems for high-performance computing. A method operates in a distributed storage cluster platform that has a storage pool and computing nodes that concurrently execute foreground tasks and background tasks. A uses interacts with a user interface to input specifications of background task time windows. Background tasks that run within the time frame of a background task time window are permitted to be scheduled at a relatively higher resource usage rate that consumes relatively higher cluster resources than do background task tasks that run outside of the background task time window. When the background task time window closes, the relatively higher resource usage rate of the running cluster background tasks is reduced to a relatively lower resource usage rate. Background tasks can self-observe the background task time windows and/or can be controlled by messages received from a virtualized controller that is designated to perform cluster-wide observations and to make cluster-wide determinations.

### RELATED APPLICATIONS

The present application claims the benefit of priority to co-pending U.S. Provisional Patent Application Ser. No. 62/298,207 titled, “ACCELERATING MAINTENANCE TASKS IN A COMPUTING CLUSTER” (Attorney Docket No. Nutanix-085-PROV), filed Feb. 22, 2016, which is hereby incorporated by reference in its entirety.

### FIELD

This disclosure relates to high-performance computing, and more particularly to techniques for observing an accelerated background task mode in a computing cluster.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The use of virtual machines (VMs) in computing platform continues to increase. Storage-related demands of such VMs has fostered development and deployment of distributed storage systems. Distributed storage systems have evolved to comprise arrangements of many autonomous nodes that cooperate so as to facilitate scaling to virtually any speed or capacity. In some cases, the distributed storage systems can comprise numerous nodes supporting multiple user VMs running a broad variation of applications, tasks, and/or processes. For example, in clusters that may host hundreds or thousands (or more) autonomous VMs, the storage I/O (input/output or IO) activity in the distributed storage system can be highly dynamic. With such large scale, highly dynamic distributed storage systems, certain system management tasks (e.g., background tasks) may be executed to maintain a uniform and/or consistent performance level as may be demanded by information technology (IT) management personnel and/or by a service level agreement (SLA) and/or as is expected by the users. In a cluster, cluster management tasks might include any node-specific system management tasks as well as tasks related to data replication (e.g., for disaster recovery, data protection policies, etc.), data movement (e.g., for disk balancing, information lifecycle management, etc.), data compression, and/or other processes. Performance of and completion of management tasks often improves performance levels of the overall system. Even though users recognize that management tasks necessarily consume at least some cluster resources (e.g., nodes, CPU time, I/O, etc.), and even though the users of the distributed storage system might recognize the benefits facilitated by the execution of management tasks, the users do not want to experience reduced system performance.

Unfortunately, legacy techniques for scheduling various administrative tasks (e.g., to run as background tasks) in a large scale, highly dynamic distributed storage system often does impact system performance as experienced by its users. For example, some legacy techniques continuously run system “scans” that continuously execute sets of probing and analysis tasks as well as other system or cluster maintenance tasks (e.g., information lifecycle management tasks, disk balancing tasks, etc.). In this case, processing might be concurrent with user interactions with the system—even during periods of user-directed mission critical activities—resulting in an impact on performance (e.g., latency increase, sluggishness, etc.) that might be observed by the user and/or that violates one or more aspects of a service level agreement (SLA). Legacy approaches result in contention for resources that occur vis-à-vis user-directed activities and management tasks. Under legacy approaches, users experience sluggishness. User experiences of sluggishness is to be avoided.

What is needed is a technique or techniques to improve over legacy and/or over other considered approaches. Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for observing an accelerated background task mode and schedule in a computing cluster, which techniques advance the relevant technologies to address technological issues with legacy approaches. More specifically, the present disclosure provides a detailed description of techniques used in systems, methods, and in computer program products for observing an accelerated background task mode and schedule in a computing cluster. Certain embodiments are directed to technological solutions for performing cluster background tasks at an accelerated pace during periods when user activity or user observability is low. The embodiments advance technical fields pertaining to computing cluster maintenance as well as advancing peripheral technical fields.

Various systems operate in a distributed storage cluster platform that has a storage pool and computing nodes that can execute foreground tasks and background tasks concurrently. A uses interacts with a user interface to input specifications of background task time windows. Background tasks that run within the time frame of a background task time window are permitted to be scheduled at a relatively higher resource usage rate that consumes relatively higher cluster resources than do background task tasks that run outside of the background task time window. When the background task time window closes, the relatively higher resource usage rate of the running cluster background tasks is reduced to a relatively lower resource usage rate. Background tasks can self-observe the background task time windows and/or can be controlled by messages received from a virtualized controller that is designated to perform cluster-wide observations and to make cluster-wide determinations.

The disclosed embodiments modify and improve over legacy approaches. In particular, the herein-disclosed techniques provide technical solutions that address the technical problems attendant to earlier cluster maintenance scheduling and/or technical problems attendant to increasing the throughput of cluster background tasks without detracting from user-experienced cluster performance. Some embodiments disclosed herein use techniques to improve the functioning of multiple systems within the disclosed environments. As one specific example, use of the disclosed techniques and devices within the shown environments as depicted in the figures provide advances in the technical field of high-performance computing as well as advances in various technical fields related to distributed storage in clustered environments.

Further details of aspects, objectives, and advantages of the technological embodiments are described herein and in the following descriptions, drawings, and claims.

### BRIEF DESCRIPTION OF THE DRAWINGS

The drawings described below are for illustration purposes only. The drawings are not intended to limit the scope of the present disclosure.

FIG. 1A1 is a performance graph showing two scenarios of cluster performance over time.

FIG. 1A2 is a graph that depicts observations of user activity as taken over a continuous time period.

FIG. 1A3, and FIG. 1A4, depict work phases in discrete time periods.

FIG. 1A5, and FIG. 1A6 depict work phases in discrete time periods, according to some embodiments.

FIG. 1B plots the seasonality of observed user demand on a time period chart.

FIG. 1C depicts a system flow used in specifying maintenance mode windows, according to some embodiments.

FIG. 1D1 and FIG. 1D2 depict dynamic background task processing techniques for observing an accelerated background task schedule and dynamically tunable policies in a computing cluster, according to some embodiments.

FIG. 2 depicts a cluster that runs multiple background task types in parallel based on node-specific schedules, according to some embodiments.

FIG. 3 depicts a background task processing technique that applies task-specific policy parameters based on the background task type, according to some embodiments.

FIG. 4A and FIG. 4B depict user interfaces used to set background task mode schedules in systems that perform accelerated background task execution in a computing cluster, according to some embodiments.

FIG. 5 presents a technique for performing accelerated background task execution in a computing cluster, according to some embodiments.

FIG. 6 depicts system components as arrangements of computing modules that are interconnected so as to implement certain of the herein-disclosed embodiments.

FIG. 7A and FIG. 7B depict architectures comprising collections of interconnected components suitable for implementing embodiments of the present disclosure and/or for use in the herein-described environments.

### DETAILED DESCRIPTION

Some embodiments of the present disclosure address the problem of increasing the throughput of cluster background tasks without detracting from user-experienced cluster performance. Some embodiments are directed to approaches to perform cluster background tasks at an accelerated pace (e.g., by scheduling more background tasks and/or by consuming more cluster resources) during periods when user-observability is low. The accompanying figures and discussions herein present example environments, systems, methods, and computer program products for observing an accelerated background task mode in a computing cluster.

### Overview

In an ongoing lifecycle of a computing cluster, various kinds of garbage collection, replication, and other maintenance activities need to be performed in order to maintain overall cluster efficiency. Such maintenance activities can be performed at low levels of cluster resource consumption such that user interaction with the cluster does not become perceivably sluggish. Due (in part) to the aforementioned low levels of cluster resource consumption of the maintenance activities it may happen that completion of some maintenance activities takes a long time. During this time, the efficiency of the cluster suffers, possibly impacting any and all tasks or interactions on the cluster.

In some cases user driven activities have a seasonal or periodic demand pattern related to the time of the day, day of the week, year, etc. To a user, it is particularly frustrating if the maintenance activities run over extended periods of time despite the fact that user activity was low during portions of that extended period of time. This problem can be addressed by adjusting the pace of maintenance task activities (e.g., by increasing the aggregate resource consumption level available to a set of background tasks). Such increased aggregate resource consumption level can be tuned to be permitted only during periods of measured and/or predicted low user interaction with the cluster. As a result, the overall cluster efficiency (e.g., cluster “healing”) is often achieved in a measurably shorter elapsed time, yet without introducing user frustration that might arise from cluster resource contention between users' foreground tasks and running cluster background tasks.

At the other extreme, there may be certain “peak” hours of user driven activities when maintenance activities are not desired. During those times, the pace of background tasks can be slowed down such that the users do not experience undue contention for cluster resources.

A cluster administrator can define a schedule specification for background tasks (e.g., comprising time windows when the user activities are low). For example, a pattern of days can be specified (e.g., by choosing days of the week, days of the month, etc.). Within a particular chosen day, one or more specific time windows (e.g., by the hour or by working shifts, etc.) can be selected. Multiple such schedules can be combined together (e.g., as in a “union” or as in a merged schedule”) to form a final overall schedule. The schedule specification may be updated at any time. For example, if a disk decommissioning is deemed to be too slow the administrator might want to speed it up. A new schedule specification may be applied at any time. Background tasks running at that point in time recognize the changed schedule and/or acceleration policy.

As discussed herein, background tasks are processes or tasks that perform cluster maintenance operations including but are not limited to:
data replication (for e.g. disaster recovery, data protection policies, etc.),
data movement (for e.g. disk balancing, information lifecycle management, etc.);
data compression;
data consistency;
data compaction;
data deduplication;
garbage collection;
load balancing;
cluster health improvement;
storage utilization improvement,
storage reclamation,
storage compaction,
storage deduplication,
storage replication,
disk balancing,
data transformation,
storage layout changes,
erasure coding and
storage performance optimization.

Such background tasks might be run on the cluster in a regime of running just a “few” at a time (e.g., consuming a modest amount of computing resources) or might be run on the cluster in an accelerated mode by running a larger number of background tasks concurrently (e.g., consuming a greater amount of computing resources). The determination as to when to run in one mode or another mode can be made at a fine-grained level (e.g., down to a day or hour or second, etc.).

Given this fine-grained level of control over scheduling in an accelerated mode, an administrator might apply more aggressive policies as a rule, knowing that at appropriate times, the pace of background activities can be slowed down such that users do not experience the effects of unwanted system resource contention. Policies can be expressed in terms of tunable parameter values such as “crank up to 90% CPU utilization” or “use up to 90% of available bandwidth”.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment. An aspect or an advantage described in conjunction with a particular embodiment is not necessarily limited to that embodiment and can be practiced in any other embodiments even if not so illustrated. Also, references throughout this specification to “some embodiments” or “other embodiments” refers to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments.

### Definitions

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Example Embodiments

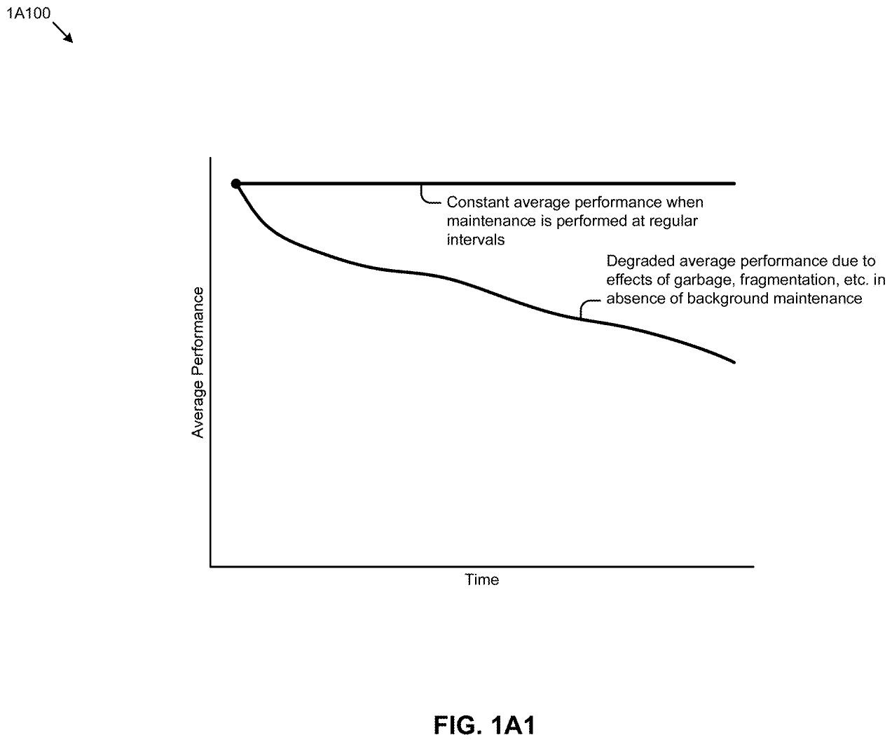

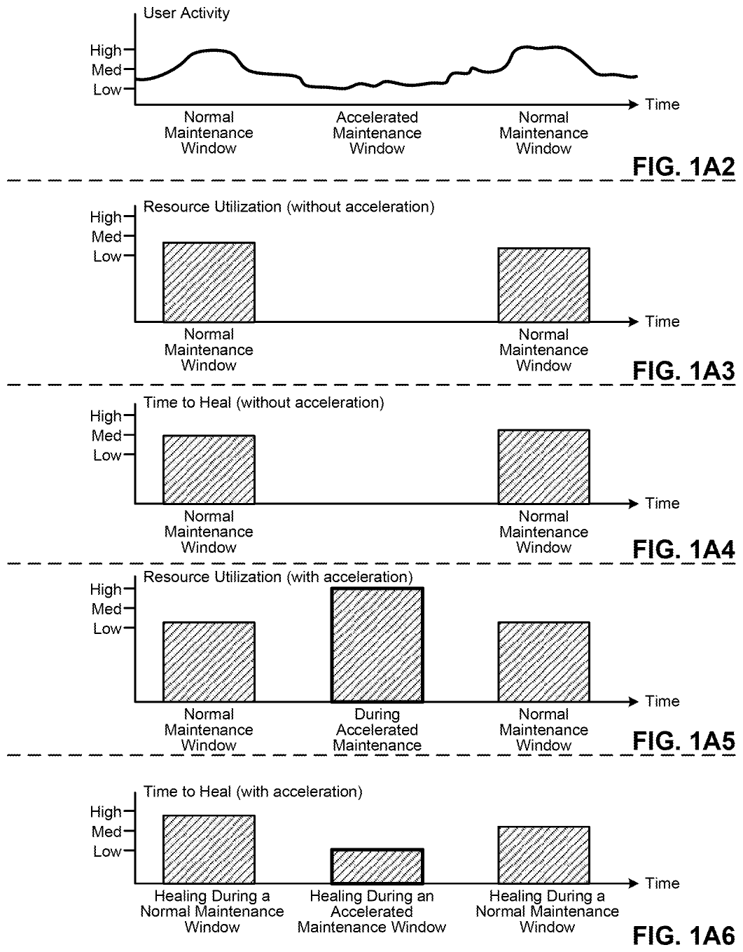

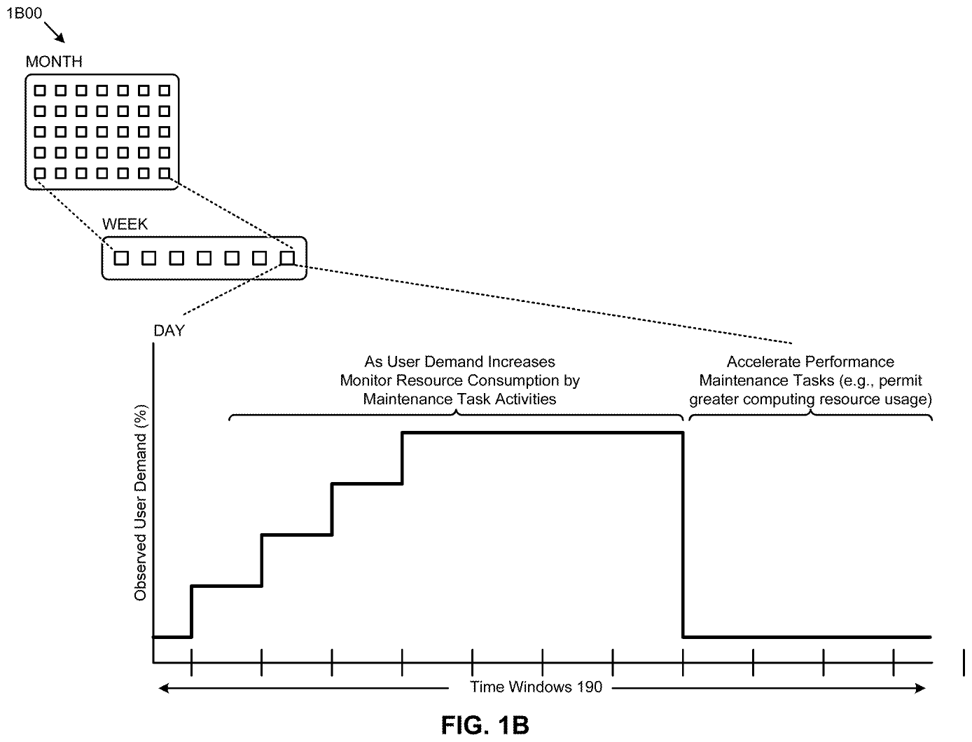

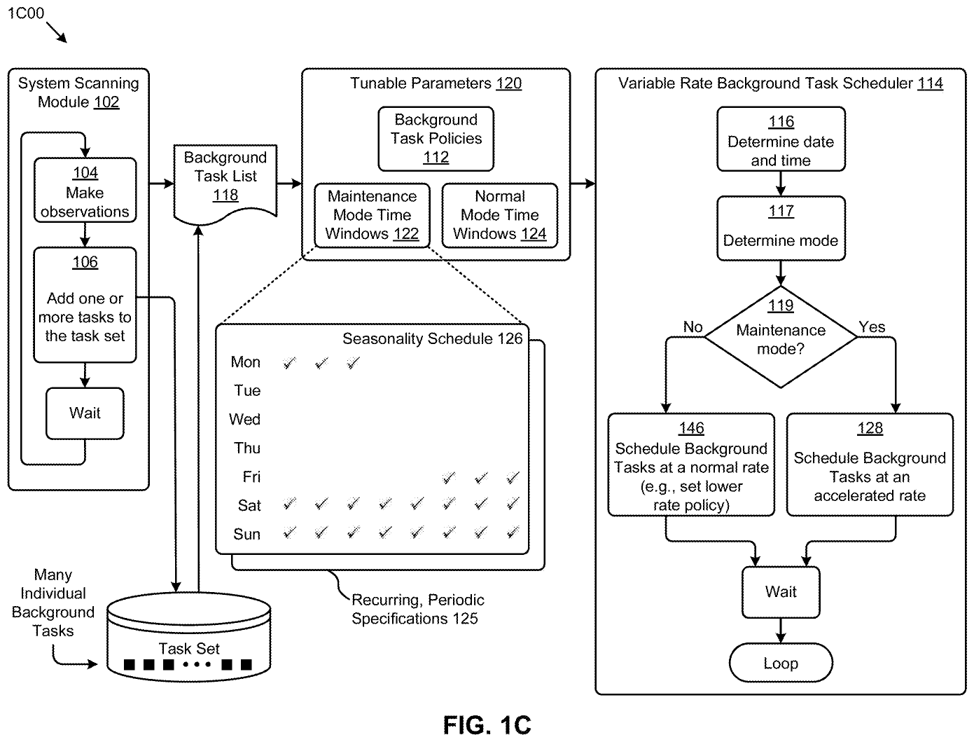

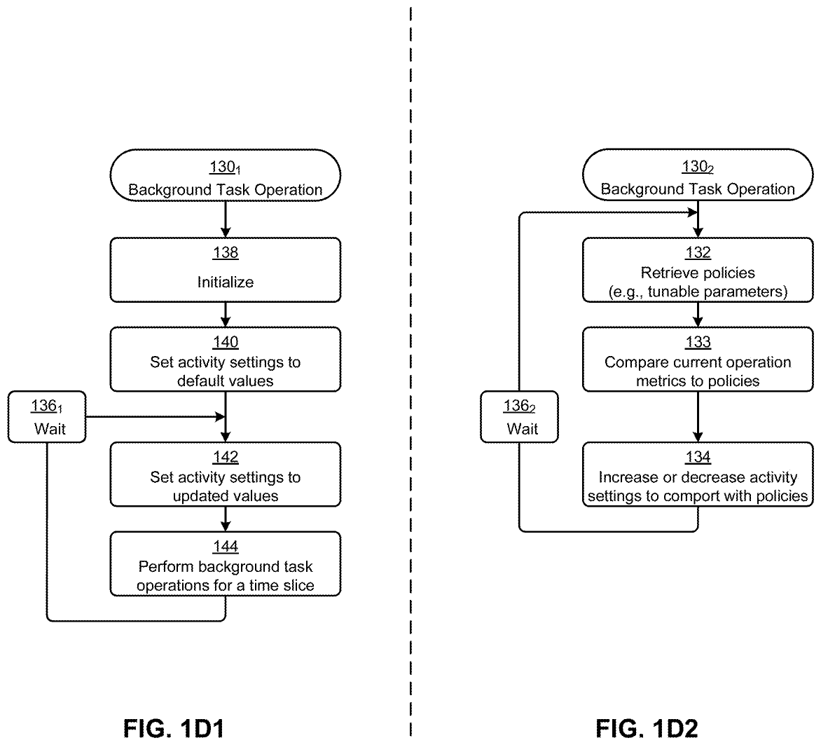

FIG. 1A1 is a performance graph 1A100 showing two scenarios of cluster performance over time. As shown, the average overall performance of a computing cluster tends to degrade over time. This is sometimes due to cluster-impacting deleterious aspects of available memory reduction (e.g., from an accumulation of dormant virtual machines, etc.), storage-related effects (e.g., disk fragmentation, disk unbalancing, etc.). All or some of such deleterious aspects can be ameliorated by performing background tasks on an ongoing basis.

As shown, a fully cleaned up cluster might exhibit constant performance such that the cluster performance does not degrade over time. In some managed cluster settings, an administrator might invoke management tasks periodically so as to clean up the cluster. In some cases, an administrator might schedule a maintenance event so as to be able to run a maintenance task (e.g., a disk-wide defragmentation). Sometime such a maintenance event is scheduled to occur well in advance of the actual occurrence, and users might be notified well in advance of the actual event, so they can adjust their demands for cluster resources while the cluster is “down for maintenance”.

However, in many settings, there is no convenient time to bring a cluster down for maintenance. Cluster background tasks need to be performed even while there are users placing computing and storage demands on the cluster. Unfortunately, when background tasks are being performed, users who are interacting with the cluster might experience a cluster “slow down” or “sluggishness”. Some techniques that are discussed herein include observation of periodicity of user interactions so as to accelerate background tasks during periods when the users are not actively interacting with the cluster and/or during periods when there is low or no user demand.

FIG. 1A2 is a graph that depicts observations of user activity as taken over a continuous time period. As shown, there are moments in time when the user activity is relatively lower. In many situations, performance aspects of a cluster can be observed (e.g., using process or operating system monitoring tools). Moreover, in many situations, and as shown, it can be observed that there are fluctuating periods of relatively higher levels of user activity, followed by periods of relatively lower levels of user activity. Such a pattern might be seasonal. For example, a user might interact with a system primarily during “work hours” on a 9-to-5, Monday-to-Friday schedule. When background tasks are run in periods that overlap with periods of relatively higher user the user might experience the reduced cluster performance.

There are situations when the cluster is not excessively busy performing foreground tasks and/or when the user is not actually observing cluster performance, such as while the user is running a big batch job or running a series of smaller batch jobs overnight. In such cases a cluster administrator might want to get as much of the background task work done as soon as possible. In fact, some administrators might be willing to identify one or more time windows (e.g., a weekly time window, a daily time window, an hour-by-hour oriented time window, etc.) to describe when the rate of launching background tasks can be accelerated so as to run a relatively larger number of background tasks and/or consume a relatively greater amount of cluster resources. In some situations the administrator may be willing delay the launching of background tasks until the end of a user interaction period, and then, at the beginning of a user inactivity period, the delayed background tasks are run in an accelerated mode (e.g., where rate of launching background is accelerated so as to run a relatively larger number of background tasks than as when the launching rate is not accelerated). Such an accelerated background task schedule can be determined, at least in part, by observing a cluster to identify periods of user inactivity, and then scheduling background tasks during periods of user inactivity. Such observations can be made by automated tasks, or can be merely observed by the system administrator, or some combination thereof. Stated otherwise, an accelerated background task schedule can be determined, at least in part, by observing a cluster to identify periods of user interaction with the cluster, and then avoiding scheduling background tasks during those periods.

FIG. 1A3, and FIG. 1A4, depict work phases in discrete time periods. As shown, a so-called normal maintenance window is observed. The maintenance work in the normal maintenance windows consume a relatively “low” amount of resources in the cluster. This is consistent with historical system administrator practices for normal maintenance. Unfortunately, most system administrator practices are conservative in their application, which sometime has an unintended effect of causing the cluster to operate with some maintenance tasks (e.g., garbage collection tasks, defragmentation tasks) unfinished, which in turn extends the time that the cluster is in an “un-healed” state. Following the historical system administrator practices, the time taken to bring a cluster to a healed state is too long (e.g., see the medium, “Med” amount of time as shown in FIG. 1A4). The effects of historical system administrator practices can be improved upon, as depicted in the following FIG. 1A5 and FIG. 1A6.

FIG. 1A5 depicts resource utilization during various periods shown as “Normal Maintenance Window”, and “During Accelerated Maintenance”. As shown, resource utilization by background tasks during a normal maintenance window is “Low”, and is relatively “High” during accelerated maintenance. Although a cursory observation that the resource utilization is relatively “High” during accelerated maintenance might be deemed to be unwanted, the effects of relatively high resource utilization can be managed by (1) scheduling the higher demand for resources during periods of user inactivity, and/or (2) seizing advantage that relatively high resource utilization results in a shorter time to heal the cluster.

FIG. 1A5 depicts time to heal during various periods shown as “Normal Maintenance Window”, as compared to “Healing During an Accelerated Maintenance Window”. As shown, the time to heal during a normal maintenance window is relatively “High”, but is relatively “Low” during an accelerated maintenance regime.

Various maintenance work phases can be scheduled by an administrator. A maintenance work phase is composed of first period in which a maintenance scan is executed, followed by execution of a (possibly large) number of maintenance tasks. The timeframes for scheduling the maintenance scan as well as the timeframe for execution of a number of maintenance tasks can be established by an administrator, with or without a policy. When a maintenance work phase is carried out, and maintenance tasks are carried out in a more aggressive, accelerated manner, the cluster can be healed sooner. More particularly, when the maintenance tasks are carried out in a more aggressive, accelerated manner during a period of user inactivity, the users foreground tasks will not be impacted. When users return to their normal activities, the cluster degradations that might have occurred during the course of ongoing use have been addressed. Still more, when there are relatively longer periods of user inactivity, the cluster is healed more extensively.

Of course it is possible that maintenance tasks (e.g., maintenance scans and maintenance worker tasks) can run within periods of user activity. In some cases it is possible that maintenance tasks can run within periods of user activity, yet without impacting user-perceived cluster performance.

In some cases background tasks have differing characteristics as pertains to CPU-boundedness, I/O (input/output or IO) boundedness, memory demands, etc. In some cases, certain types of background task (e.g., an analysis tool that merely identifies tasks to be performed) can be run in a period of user interaction without introducing user-perceived cluster degradation. In some situations, background tasks can be divided into two types: (1) scan tasks that are relatively lighter-weight and perform substantially only probing scan and analysis tasks, and (2) action tasks that are relatively higher-weight and perform tasks that involve relatively higher CPU usage, and/or a relatively higher rate of storage I/O operations, and/or a relatively higher demand for network bandwidth, etc.

In some cases a cluster-wide policies pertaining to resource utilization can be codified into rules. For example:
Rule: Do not run in maintenance mode outside of a specified maintenance window (e.g., observe only established schedules for accelerated maintenance, and/or observe resource usage limits).
Rule: Schedule scan tasks to be performed in accordance with a repeating periodicity (e.g., run probing scan tasks at least once per day).
Rule: Prioritize background probing or scan tasks over other background tasks (e.g., prioritize determination of what maintenance activities need to be prescribed over actually performing the work of the maintenance tasks).
Rule: Observe background task generation rate parameters (e.g., number of scheduled tasks per second).
Rule: Observe background task resource consumption limit parameters (e.g., do not schedule more background tasks than would exceed a limit for aggregate CPU limitation).
Rule: Observe analysis depth parameters (e.g., observe periods for aggressive in-depth analysis by scan tasks, or less aggressive less in-depth scan task analysis).
Rule: Observe scan tasks resource consumption limit parameters (e.g., do not schedule more scan tasks than would exceed a limit for aggregate CPU limitation).

The aforementioned rules and other uses of resource consumption levels may pertain to resource usage metrics or limits such as maximum permitted storage I/O operations per second, maximum network bandwidth, minimum CPU headroom, availability, etc. When such rules are observed in a cluster, at least two effects become apparent: (1) compared to clusters without probing and accelerated maintenance, the cluster is diagnosed and healed sooner, and (2) the cluster is healed more extensively.

The seasonality of user demand can be observed, either by a system administrator, or by a probing task. A system administrator can establish time window descriptions composed of successive time segments, which time segments can be deemed to be available for aggressive background task scheduling (e.g., to define a maintenance mode) and which time segments are to be deemed as normal mode time periods.

FIG. 1B plots the seasonality of observed user demand on a time period chart 1B00. As an option, one or more variations of time period chart 1B00 or any aspect thereof may be implemented in the context of the architecture and functionality of the embodiments described herein. The time period chart 1B00 or any aspect thereof may be implemented in any environment.

The embodiment shown in FIG. 1B is merely one example of a time breakdown to a recurring seasonality period of approximately one day. As shown, observed user demands (e.g., expressed as a percent of total availability) vary over time. The observations include a period of relatively lower but increasing user demand during certain time windows 190. Time window descriptions can be composed of successive time segments, minute-by-minute time window descriptions windows, hour-by-hour time window descriptions windows, etc. Strictly as an example, a demand breakdown might be modeled in three-hour granularity, noting that the demand is relatively increasing between certain hours (e.g., between the hours of about 5 AM and about 3 PM), at which time the user demand remains high until 3 AM, then drops off precipitously. Given this set of observations, a desired schedule is to decrease background task activities beginning about noon on that day, perhaps successively decreasing or stopping background tasks through to about 3 AM, and then, at 3 AM when the seasonal user demand drops off precipitously, aggressively increasing background task activities.

### Modes and Policies

In addition to a nominal resource usage level of background tasks, this disclosure introduces the notion of recurring maintenance windows when the background tasks run at relatively higher rates of resource consumption, and/or when many more background tasks are scheduled to run in a pre-specified maintenance window.

In one aspect of some embodiments, background tasks can be run in a mode such that many analysis scans can be run, but the workload or background tasks to be performed (e.g., as determined by the analysis scans) are run using a relatively lower rate of resource consumption and/or are delayed until at least the beginning of a new maintenance window. Recurring maintenance windows can be specified as recurring periodic specifications of any aspects of seasonality. Such recurring periodic specifications can be input by an administrator through a user interface. FIG. 1C shows and discusses several techniques for establishing administrative settings, which settings can be observed when performing accelerated background task scheduling in a computing cluster.

FIG. 1C depicts a system flow 1C00 used in specifying maintenance mode windows. As an option, one or more variations of system flow 1C00 or any aspect thereof may be implemented in the context of the architecture and functionality of the embodiments described herein. The system flow 1C00 or any aspect thereof may be implemented in any environment.

The aforementioned modes and policies are replete with a rich set of administrative settings pertaining to schedule configuration, capabilities, and constraints.

For example, using a graphical user interface (GUI) or a command line interface (CLI), there are various ways of selecting a day, for example a day of the week, a day of the month, etc. For such a selected day, there can be one or more maintenance windows. A maintenance window is specified by a start time and a duration or a start time and an end time. In some cases a maintenance window is specified to include a periodicity (e.g., daily periodicity, weekly periodicity, etc.). In some cases a maintenance window specification is defined with respect to a specific day of the week, or with respect to a specific days of a month, etc.

Inputting a seasonality of maintenance window schedules can be facilitated with a seasonality schedule 126, as shown in FIG. 1C. As an alternative, a command line interface can be provided. Table 1 presents several example command line commands.

TABLE 1
Example command line interface commands

| Ref | Example Command Line Interface Syntax |
|---|---|
| 1 | $manager_cli manager_maintenance_window |
| 2 | $manager_cli manager_maintenance_window set=true |
| | schedule_name=demo days_of_week=−1 start_hhmm=1000 |
| | duration_hhmm=0200 |
| 3 | $manager_cli manager_maintenance_window list=true count=3 |

The upcoming window list:
demo (Tue Nov 24 10:00:00 2015 - Tue Nov 24 12:00:00
2015)
demo (Wed Nov 25 10:00:00 2015 - Wed Nov 25 12:00:00
2015)
demo (Thu Nov 26 10:00:00 2015 - Thu Nov 26 12:00:00
2015)

Ref #1 serves to define a handle for a window data structure that can thenceforth by referring to the given handle.

Ref #2 serves to establish a maintenance window, namely a window that begins at 10 AM (“1000”) and ends two hours later.

Ref #3 serves to display a set of upcoming maintenance windows as may have been previously defined.

In addition to operation in accordance with a maintenance mode or policy, background tasks can be scheduled to run in a normal mode, where only background task types that exhibit low resource usage (e.g., scan tasks) are executed. In normal mode, any background tasks that are running, or might have been scheduled to be run are deferred until a new maintenance mode time window is reached.

As shown in FIG. 1C, a set of background task policies (e.g., background task policies 112) can include any number of tunable parameters 120, which in turn can be set in accordance with a seasonality schedule. A particular tunable parameter can hold a value such as an integer or a floating point number, or can hold a Boolean value such as TRUE/FALSE, or as depicted by a checkmark (as shown). A user interface (e.g., the aforementioned GUI or CLI) can be used to establish a seasonality schedule for a particular tunable parameter or mode, which in turn can become a set of updated background task policies (e.g., background task launching rate policies). In some embodiments, and as shown, time periods for entering and/or exiting a mode can be established via a GUI that supports the semantics of the checkmarks. In the example given, the administrator sets a series of maintenance windows that correspond to weekends (e.g., “Sat” and “Sun”, as shown), as well as establishing maintenance windows to occur late on Fridays and early on Mondays. A different site might exhibit different seasonality, and/or a different administrator might select different time periods for maintenance windows.

A user interface for defining and entering the maintenance mode time windows 122 as well as settings for defining and entering the normal mode time windows 124 can be established separately. A conflict resolver serves to resolve conflicts should they occur. Conflicts can arise due to the nature of the man-machine interface, and/or conflicts can arise due to changing conditions observable on the cluster.

Various activities are performed in the system flow 1C00 prior to administrator consideration of the tunable parameters 120. As shown, a set of scanning tasks (e.g., the shown system scanning module 102) make observations over the cluster (see step 104), and based on the observations, one or more worker tasks are added to the task set (see step 106). This process of scanning can be repeated any number of times. New observations may add additional tasks to the task set. In exemplary cases a scan or series of scans might introduce dozens or score, or thousands, or millions of worker tasks to the task set. In some cases, a worker task is a “light” task, and in other cases a worker task is a “heavier” task. A worker task in the task set includes task definitions and task parameters, some of which parameters might have been provided by operation of the scan (e.g., by the system scanning module 102).

A background task list 118 is composed of some or all of the tasks in the task set. Such a background task list 118 is provided to and/or through the tunable parameters module, which in turn passes the background task list to a variable rate background task scheduler 114. The variable rate background task scheduler take as an input any of the tunable parameters, including the seasonality schedule 126, possibly with an sets of recurring periodic specifications 125. Based on the background task list, the seasonality schedule and any recurring periodic specifications, the variable rate background task scheduler can conditionally accelerate worker task scheduling (e.g., when inside of a maintenance mode time window) or can conditionally back off of worker task scheduling, and/or can signal worker tasks to suspend their work until a later time.

More specifically, based on a current date and time (see step 116) and a seasonality schedule 126, the variable rate background task scheduler can determine the then-current mode (see step 117) based on a calculation of a time-wise overlapping maintenance mode time window. A decision is taken to take a “Yes” branch, if the then-current mode is a maintenance mode (see the “Yes” branch of decision 119). A decision is taken to take a “No” branch, if the then-current mode is a normal mode (see the “No” branch of decision 119). In the former case, when the “Yes” branch is taken, the background tasks from the background task list 118 are schedule at an accelerated rate (see step 128). In the latter case, when the “No” branch is taken, the background tasks from the background task list 118 are schedule at a normal rate (see step 146). The variable rate background task scheduler will wait a duration, then loop to the top and again seek to determine the current date and time (at step 116).

FIG. 1D1 and FIG. 1D2 depict dynamic background task processing techniques for observing an accelerated background task schedule and dynamically tunable policies in a computing cluster. As an option, one or more variations of a multi-threaded background task processing technique or any aspect thereof may be implemented in the context of the architecture and functionality of the embodiments described herein. The multi-threaded background task processing technique or any aspect thereof may be implemented in any environment.

A background task can include multiple concurrently running operations. As shown, a background task operation 130₁ initializes its data structures and parameters (at step 138), possibly including setting throttles and other activity settings to establish or override default values (see step 140). As the flow progresses, it enters a loop that comprises a step for setting/resetting activity values (see step 142) followed by a step for performing a particular background task in accordance with the updated settings (see step 144). The loop continues indefinitely, possibly passing through a wait state (at step 136₁).

The aforementioned policies may be composed of any number of tunable parameters. A background task operation 130₂ can retrieve policies (see step 132) and/or corresponding parameters, which are compared to current operation metrics (at step 133) and logic is performed so as to adjust (e.g., increase or decrease) the throttling of activities so as to comport with the retrieved policies (at step 134). The aforementioned steps are performed in a loop with a wait state (at step 136₂) between loop iterations.

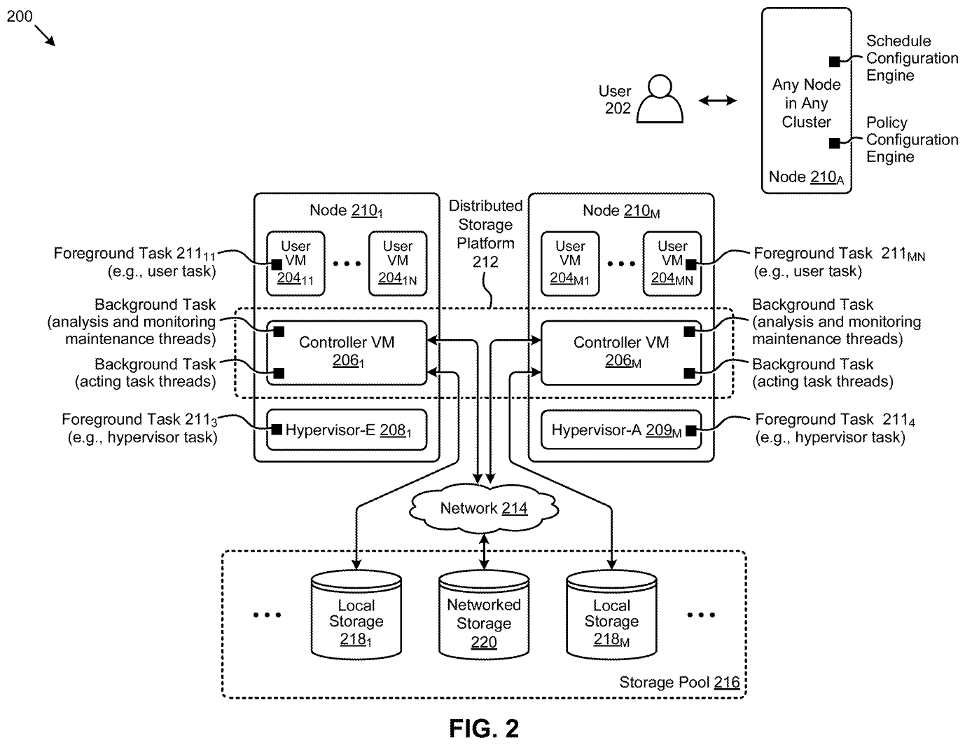

The specific particular background task type that is performed in accordance with the updated settings can be any of a wide variety of task types, or functions. Moreover the background tasks can be run in any context, in a series or pipeline or in parallel. Some of such contexts are shown and described as pertaining to FIG. 2.

FIG. 2 depicts a cluster 200 that runs multiple background task types in parallel based on node-specific schedules. As an option, one or more variations of cluster 200 or any aspect thereof may be implemented in the context of the architecture and functionality of the embodiments described herein. The cluster 200 or any aspect thereof may be implemented in any environment.

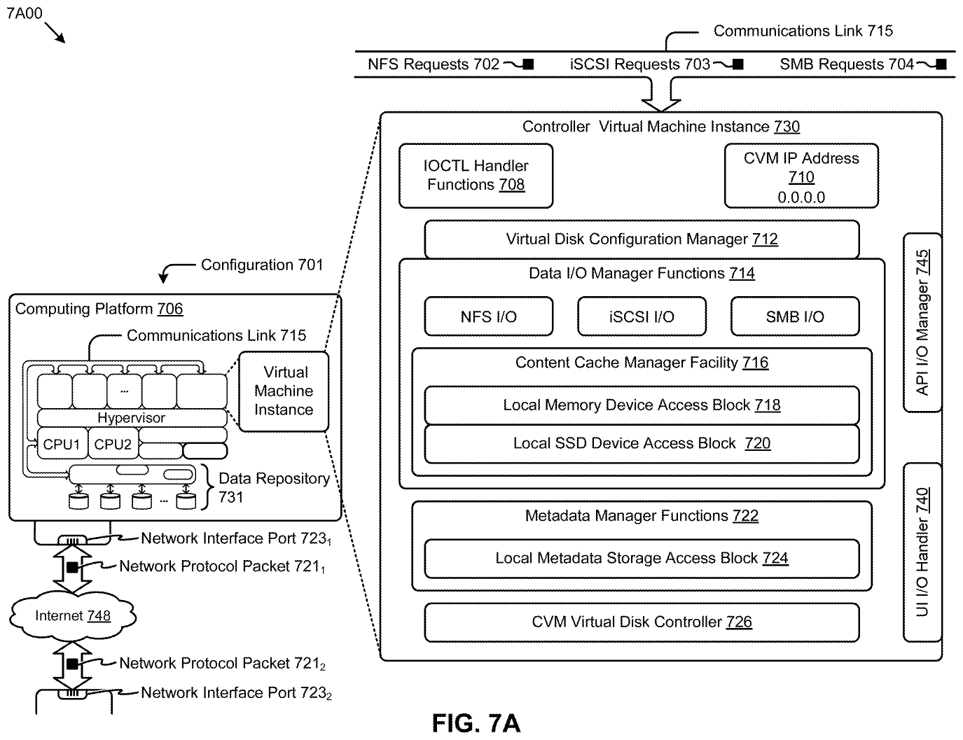

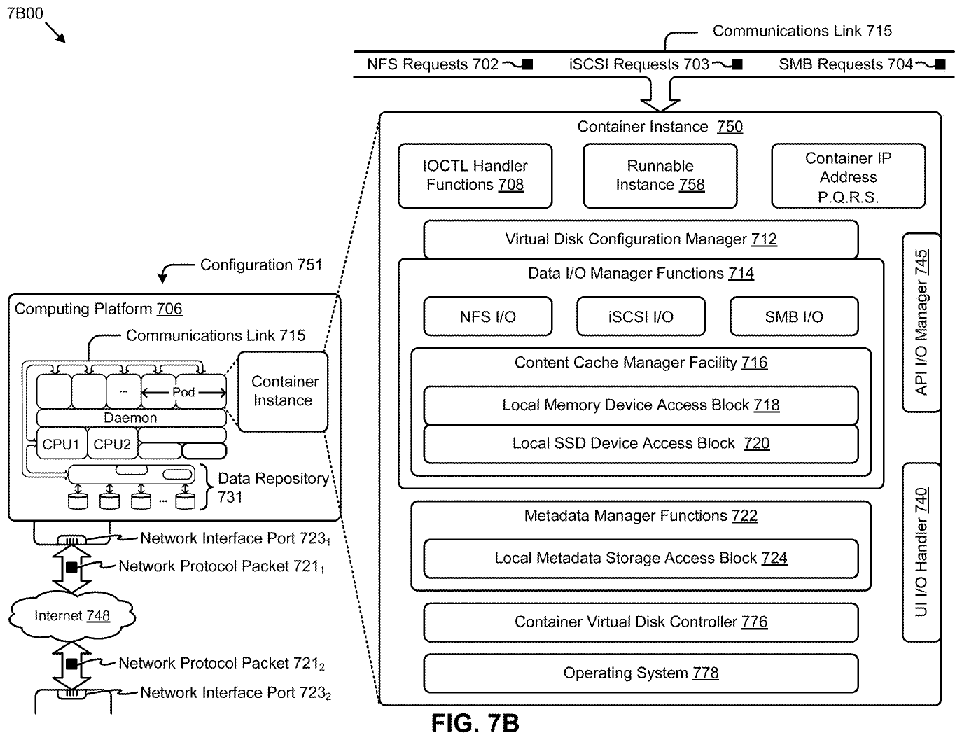

The embodiment shown in FIG. 2 is merely one example of a cluster 200. As shown, the architecture and organization of the components facilitate various interactions among representative components of the distributed storage platform 212. A plurality of nodes (e.g., node 210₁, node 210_{M} and node 210_{A}) can support any number of virtualized controllers (e.g., controller VM 206₁, controller VM 206_{M}, etc.) and/or any number of user virtual machines (e.g., user VM 204₁₁, . . . , user VM 204_{1N}, user VM 204_{M1}, . . . , user VM, etc.). In some embodiments, the virtualized controllers and/or VMs operate over a hypervisor (e.g., hypervisor-E 208₁, hypervisor-A 209_{M}). The hypervisor can be of any type or vendor. In some embodiments, any of the functions of the virtualized controllers and/or any of the functions of the user processes can operate in a container implementation (see FIG. 7A and FIG. 7B). Any combination of VMs communicate with storage in a storage pool 216, which can be accessed over network 214 and/or over any direct-attached storage I/O facility as may be provided by the hardware of the distributed storage platform 212. In this embodiment, foreground tasks are run within user VMs (e.g., foreground task 211₁₁, foreground task 211_{MN}) and/or within hypervisors (e.g., foreground task 211₃, and foreground task 211₄). Background tasks are run within or in conjunction with a respective controller virtual machine (CVM).

The storage pool shown is composed of networked storage 220 as well as any number of units of local storage (e.g., local storage 218₁, local storage 218_{M}, etc.).

Further details regarding general approaches to virtual machine and storage pools are described in U.S. Pat. No. 8,601,473 titled “ARCHITECTURE FOR MANAGING I/O AND STORAGE FOR A VIRTUALIZATION ENVIRONMENT”, (Attorney Docket No. Nutanix-001) which is hereby incorporated by reference in its entirety.

An administrator (e.g., user 202) can access a schedule configuration engine and/or a policy configuration engine, either of which can operate on any node in any cluster.

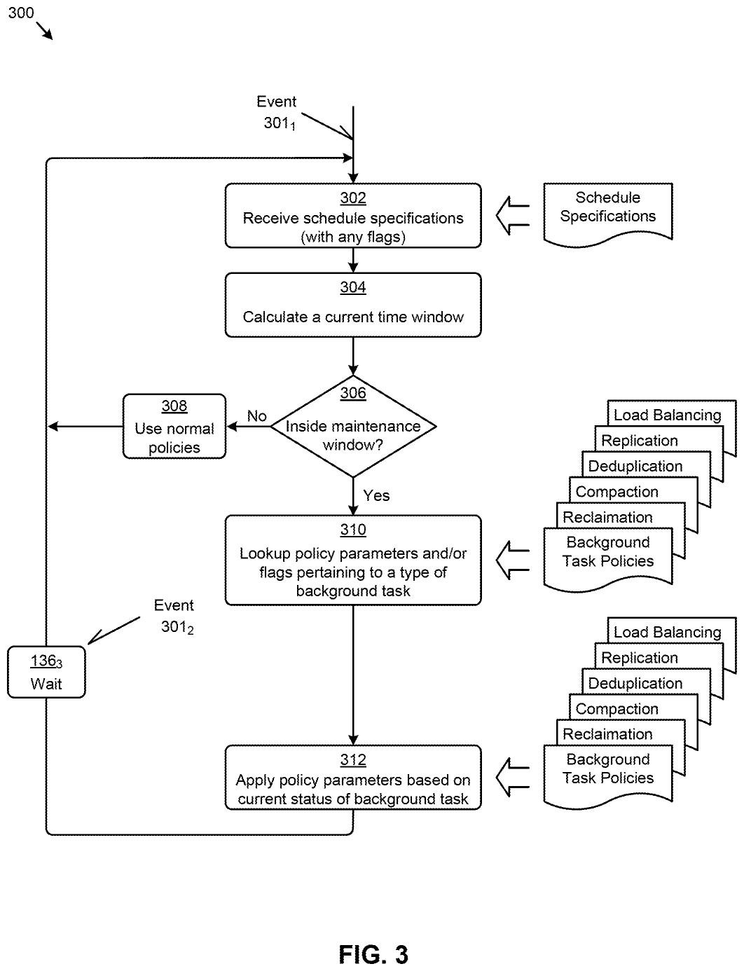

The schedule configuration engine and/or the policy configuration engine can, in some cases, provide a GUI to the user, and/or can provide a command line interface to the user. Any of the background tasks (e.g., the shown analysis and monitoring maintenance threads and/or the shown acting task threads) can operate on any one or more nodes of the cluster in compliance with a node assignment and/or schedule as entered by a user. The schedule configuration engine and/or the policy configuration engine can accept and/or process user input that specifies certain nodes of the cluster to host (or not to host) background task assignments. For example, on a cluster having N nodes, a user might specify that only some subset of the N nodes are to be hosts for background tasks. Such a specification might include discrete allow/deny specifications of a mode for a node, and/or might specify ranges or limits as to the number of background tasks to run concurrently on a particular node. Any particular type of background task processing can observe task-specific policy parameters based on the background task type. One possible technique to do so is shown and described as pertains to FIG. 3.

FIG. 3 background task processing technique 300 that observes task-specific policy parameters based on the background task type. As an option, one or more variations of background task processing technique 300 or any aspect thereof may be implemented in the context of the architecture and functionality of the embodiments described herein. The background task processing technique 300 or any aspect thereof may be implemented in any environment.

The depicted background task processing technique is entered upon an event 301₁. The event can result from a save action taken by a user when using a schedule configuration engine and/or a policy configuration engine, or the shown event can be raised from an action that results from merely moving from one time period to another time period. The shown technique includes a step to retrieve a schedule specification, together with any flags (see step 302). Processing continues at step 304 to calculate a current time window. A time window can have any granularity. For example, a cluster might be managed on a daily basis, or managed on an hourly basis, or even on a smaller (or larger) granularity. Any time granularity can be converted into any other time granularity such that a current time slice can be projected onto a schedule specification at any (same or other) degree of granularity. After projection of the current time window onto the schedule, the mode and maintenance window bounds are determined. If the current moment is not within a maintenance window (e.g., see the “No” branch of decision 306) then the normal policies are applied (see step 308). If the current moment is within a maintenance window (e.g., see the “Yes” branch of decision 306) then a lookup operation (see step 310) is performed to detect if some parameters or values might have changed vis-à-vis the previous time window. In such a case, policy parameters or values and/or flags pertaining to a particular type of background task are applied (see step 312). Any given type of background task can be associated with a respective set of policies, parameters, and/or flags.

Policies and respective policy values can include:
Rates of background task scheduling (e.g., more aggressive acceleration results in more background tasks being scheduled to run in a particular time window). A particular rate of background task scheduling can be responsive to the particular type of background task being considered for scheduling.
Limits on maximum resource usage per unit of time (e.g., aggressive acceleration of background tasks can be throttled based on a maximum limit pertaining to a particular resource type).
Depth of analysis (e.g., to permit or deny more aggressive probing and/or cluster analysis).
Extent of work done by background task (more aggressive implies more work).

In some cases policy values are changed at time window boundaries. For example, a policy value might be set higher at the leading edge of a maintenance mode time window, and then set lower at the trailing edge of a maintenance mode time window. In other cases, a particular maintenance mode policy value overrides a default value during a maintenance mode time window. Outside of the maintenance mode time window, the policy value reverts to the default value. The policy values, including default value can be established by a cluster administrator, or can be established based on observations made by any of the aforementioned probing scan and/or cluster analysis tasks.

At step 312, after the policies, policy parameters, and/or flags have been retrieved (e.g., at step 310), they can be applied based on the current status of the respective background tasks. For example, if the current time is within a maintenance mode window, then the respective set of background task might run at an increased aggregate resource usage level. After making changes, a wait state 136₃ is entered. Upon expiration of the wait state, the loop is again entered at step 302. An event 301 can trigger movement out of the wait state and into immediate re-execution at step 302.

There are some flags that are applicable throughout an entire maintenance window. There are also some flags that are applicable only during a particular loop (e.g., a loop of a scan task). Such flags are applied upon invocation of a scan task and remain active until the beginning of the next scan, at which time they may be overwritten by new values.

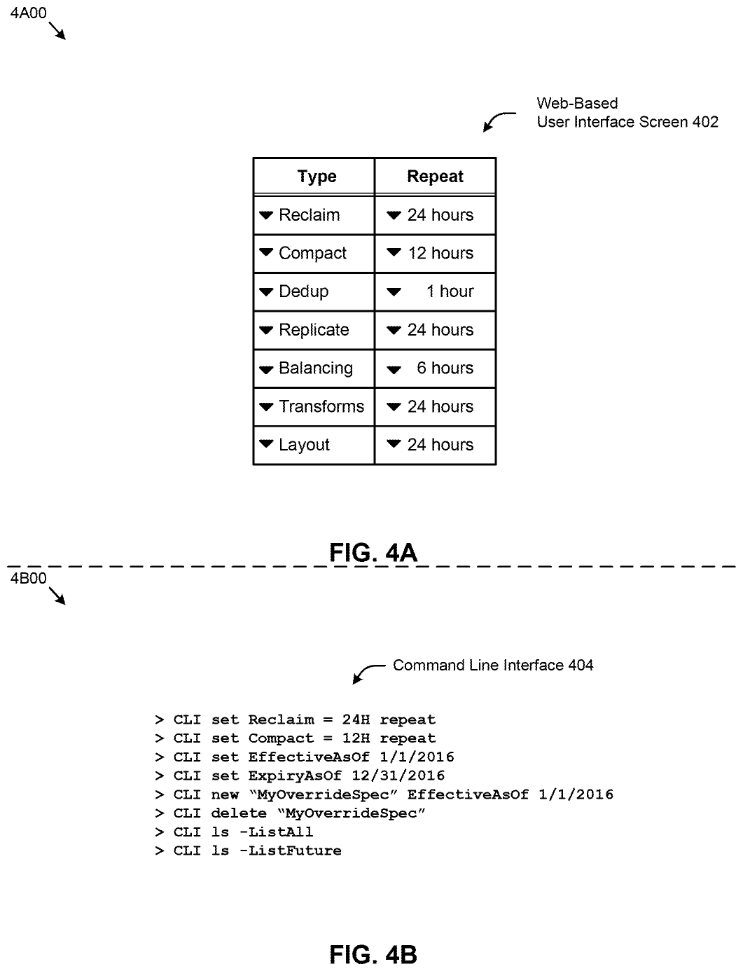

FIG. 4A depicts a graphical user interface 4A00 used to set maintenance mode schedules in systems that perform accelerated background task execution in a computing cluster. As an option, one or more variations of graphical user interface 4A00 or any aspect thereof may be implemented in the context of the architecture and functionality of the embodiments described herein. The graphical user interface 4A00 or any aspect thereof may be implemented in any environment.

The embodiment shown in FIG. 4A presents one example of a web-based user interface screen 402. The “Type” column comprises pull-down menus that are populated with short names for background task types (e.g., reclamation tasks, compaction tasks, deduplication tasks, replication tasks, load/disk balancing tasks, and/or layout tasks, etc.). Each row can be used to define and display a schedule. A schedule in turn can be a repeating schedule having a start indication and an applicability indication. In some embodiments, additional columns are provided, for example, to allow additional data (e.g., transform identification) to be included in the schedule. Such a transform indication can be used, for example, when converting from one storage layout scheme to another storage layout scheme.

FIG. 4B depicts a command line user interface 4B00 used to set maintenance mode schedules in systems that perform accelerated background task execution in a computing cluster. As an option, one or more variations of command line user interface 4B00 or any aspect thereof may be implemented in the context of the architecture and functionality of the embodiments described herein. The command line user interface 4B00 or any aspect thereof may be implemented in any environment.

As shown, a command line interface 404 can be used to define a particular schedule (e.g., a daily repeating schedule) for a particular type of background task (see “set Reclaim=24H repeat”, and “set Compact=12H repeat”). Additional command line commands support operations for:
establishing an effective date for a default or other schedule (e.g., see “EffectiveAsOf” keyword);
establishing a date of expiry for a default or other schedule (e.g., see “ExpiryAsOf” keyword);
overriding a default schedule specification (e.g., see “new” keyword and the name of the override schedule “MyOverrideSpec” to be added);
removal of previously saved maintenance window specifications (e.g., see the “delete” keyword and the name of the override schedule “MyOverrideSpec” to be deleted);
listing of maintenance window specifications (e.g., see “Is—ListAll”); and
listing of future maintenance window time durations (e.g., see “Is—ListFuture”).

In some situations two or more maintenance window specifications can be combined or aggregated. Overlapping periods are permitted (e.g., merged into a single window). Conflicts between two or more saved maintenance window specifications can be automatically resolved based on a policy (e.g., winner based on user, winner based on date of creation, etc.).

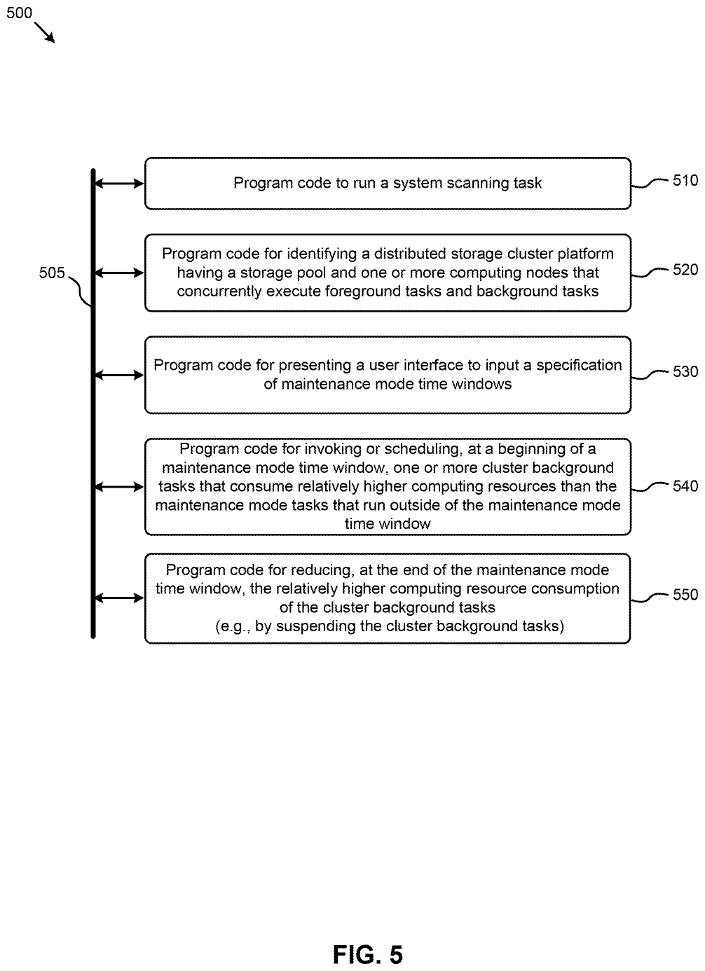

The foregoing discusses an administratively established schedule for performing background tasks during periods of expected low user interaction with the cluster. In some cases, and as shown and discussed as pertaining to FIG. 5, a schedule can be generated based on a recommendation (e.g., a recommendation that an administrative user can choose to accept or reject).

FIG. 5 depicts a system 500 as an arrangement of computing modules that are interconnected so as to operate cooperatively to implement certain of the herein-disclosed embodiments. The partitioning of system 500 is merely illustrative and other partitions are possible. As an option, the system 500 may be implemented in the context of the architecture and functionality of the embodiments described herein. Of course, however, the system 500 or any operation therein may be carried out in any desired environment.

The system 500 comprises at least one processor and at least one memory, the memory serving to store program instructions corresponding to the operations of the system. As shown, an operation can be implemented in whole or in part using program instructions accessible by a module. The modules are connected to a communication path 505, and any operation can communicate with other operations over communication path 505. The modules of the system can, individually or in combination, perform method operations within system 500. Any operations performed within system 500 may be performed in any order unless as may be specified in the claims.

The shown embodiment implements a portion of a computer system, presented as system 500, comprising a computer processor to program code to run a system scanning task (see module 510) and modules for accessing memory to hold program code instructions to perform: identifying a distributed storage cluster platform having a storage pool and one or more computing nodes that concurrently execute foreground tasks and background tasks (see module 520); presenting a user interface to input a specification of maintenance mode time windows (see module 530); invoking or scheduling, at a beginning of a maintenance mode time window, one or more cluster background tasks that consume relatively higher computing resources than the maintenance mode tasks that run outside of the maintenance mode time window (see module 540); and reducing, at the end of the maintenance mode time window, the relatively higher computing resource consumption of the cluster background tasks, such as by suspending the cluster background tasks (see module 550).

Variations of the foregoing may include more or fewer of the shown modules and variations may perform more or fewer (or different) steps, and/or may use data elements in more (or fewer) or different operations.

Strictly as examples, some variations include:
Variations further comprising acts for receiving an hour-by-hour oriented time window description.
Variations further comprising acts of observing CPU utilization, node utilization, and storage I/O rates on the cluster to determine a seasonality period of utilization.
Variations further making a recommendation based at least in part on the seasonality period.
Variations where the background tasks perform at least one aspect of, storage reclamation, or storage compaction, or storage deduplication, or storage replication, or disk balancing, or data transformation, or storage layout changes, or any combination thereto.
Variations further comprising acts of receiving a policy change that updates at least one parameter pertaining to, storage reclamation, or storage compaction, or storage deduplication, or storage replication, or disk balancing, or data transformation, or storage layout changes, or any combination thereof.
Variations where the user interface is at least one of, a graphical user interface, or a command line interface, or any combination thereto.
Variations where the time window description is described using a graphical user interface.
Variations where the time window description is described using command line interface.
Variations further comprising acts of entering a normal mode.

### ADDITIONAL EMBODIMENTS OF THE DISCLOSURE

### Additional Practical Application Examples

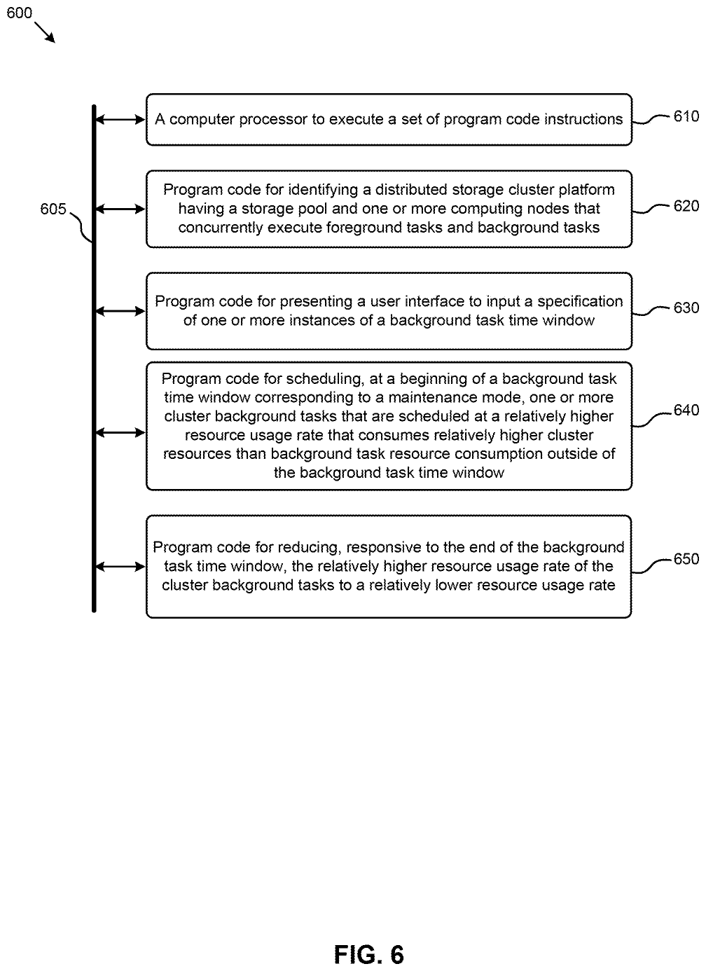

FIG. 6 depicts a system 600 as an arrangement of computing modules that are interconnected so as to operate cooperatively to implement certain of the herein-disclosed embodiments. The partitioning of system 600 is merely illustrative and other partitions are possible. As an option, the system 600 may be implemented in the context of the architecture and functionality of the embodiments described herein. Of course, however, the system 600 or any operation therein may be carried out in any desired environment. The system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with other operations over communication path 605. The modules of the system can, individually or in combination, perform method operations within system 600. Any operations performed within system 600 may be performed in any order unless as may be specified in the claims. The shown embodiment implements a portion of a computer system, presented as system 600, comprising a computer processor to execute a set of program code instructions (see module 610) and modules for accessing memory to hold program code instructions to perform: identifying a distributed storage cluster platform having a storage pool and one or more computing nodes that concurrently execute foreground tasks and background tasks (see module 620); presenting a user interface to input a specification of one or more instances of a background task time window (see module 630); scheduling, at a beginning of a background task time window corresponding to a maintenance mode, one or more cluster background tasks that are scheduled at a relatively higher resource usage rate that consumes relatively higher cluster resources than background task resource consumption outside of the background task time window (see module 640); and reducing, responsive to the end of the background task time window, the relatively higher resource usage rate of the cluster background tasks to a relatively lower resource usage rate (see module 650).

### System Architecture Overview

### Additional System Architecture Examples

FIG. 7A depicts a virtualized controller in a virtual machine architecture 7A00 comprising a collection of interconnected components suitable for implementing embodiments of the present disclosure and/or for use in the herein-described environments. The shown virtual machine architecture 7A00 includes a virtual machine instance in a configuration 701 that is further described as pertaining to the controller virtual machine instance 730. A controller virtual machine instance receives block I/O (input/output or IO) storage requests as network file system (NFS) requests in the form of NFS requests 702, and/or internet small computer storage interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., see CVM IP address 710. Various forms of input and output (I/O or IO) can be handled by one or more IO control handler functions (see IOCTL functions 708) that interface to other functions such as data IO manager functions 714 and/or metadata manager functions 722. As shown, the data IO manager functions can include communication with a virtual disk configuration manager 712 and/or can include direct or indirect communication with any of various block IO functions (e.g., NFS TO, iSCSI IO, SMB TO, etc.).

In addition to block IO functions, the configuration 701 supports IO of any form (e.g., block TO, streaming TO, packet-based TO, HTTP traffic, etc.) through either or both of a user interface (UI) handler such as UI IO handler 740 and/or through any of a range of application programming interfaces (APIs), possibly through the shown API IO manager 745.

The communications link 715 can be configured to transmit (e.g., send, receive, signal, etc.) any types of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases the payload comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 730 includes a content cache manager facility 716 that accesses storage locations, possibly including local dynamic random access memory (DRAM) (e.g., through the local memory device access block 718) and/or possibly including accesses to local solid state storage (e.g., through local SSD device access block 720).

Common forms of computer readable media includes any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 731, which in turn can be formatted into any one or more storage areas, and which can comprise parameterized storage accessible by a key (e.g., a filename, a table name, a block address, an offset address, etc.). An external data repository 731 can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 724. The external data repository 731 can be configured using a CVM virtual disk controller 726, which can in turn manage any number or any configuration of virtual disks.

Execution of the sequences of instructions to practice certain embodiments of the disclosure are performed by a one or more instances of a processing element such as a data processor, or such as a central processing unit (e.g., CPU1, CPU2). According to certain embodiments of the disclosure, two or more instances of a configuration 701 can be coupled by a communications link 715 (e.g., backplane, LAN, PTSN, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). The configuration 701 can be addressed through one or more network interface ports using an IP address. Any operational element within computing platform 706 can perform sending and receiving operations using any of a range of network protocols, possibly including network protocols that send and receive packets (e.g., see network protocol packet 721₁ and network protocol packet 721₂).

The computing platform 706 may transmit and receive messages that can be composed of configuration data, and/or any other forms of data and/or instructions organized into a data structure (e.g., communications packets). In some cases, the data structure includes program code instructions (e.g., application code) communicated through Internet 748 and/or through any one or more instances of communications link 715. Received program code may be processed and/or executed by a CPU as it is received and/or program code may be stored in any volatile or non-volatile storage for later execution. Program code can be transmitted via an upload (e.g., an upload from an access device over the Internet 748 to computing platform 706). Further, program code and/or results of executing program code can be delivered to a particular user via a download (e.g., a download from the computing platform 706 over the Internet 748 to an access device).

The configuration 701 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor. Some embodiments include one or more special-purpose hardware components (e.g., power control, logic, sensors, transducers, etc.). A module may include one or more state machines and/or combinational logic used to implement or facilitate the operational and/or performance characteristics pertaining to defining and observing an accelerated background task mode in a computing cluster.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects pertaining to defining and observing an accelerated background task mode in a computing cluster). Such files or records can be brought into and/or stored in volatile or non-volatile memory.

FIG. 7B depicts a virtualized controller in a containerized architecture 7B00 comprising a collection of interconnected components suitable for implementing embodiments of the present disclosure and/or for use in the herein-described environments. The shown containerized architecture 7B00 includes a container instance in a configuration 751 that is further described as pertaining to the container instance 750. The configuration 751 includes a daemon (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The daemon can perform port forwarding to any container (e.g., container instance 750). A container instance can be executed by a processor. Runnable portions of a container instance sometimes derive from a container image, which in turn might include all, or portions of any of, a Java archive repository (JAR) and/or its contents, a script or scripts and/or a directory of scripts, a virtual machine configuration, and may include any dependencies therefrom. In some cases a virtual machine configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container (e.g., a Docker container) can be rooted in a directory system, and can be accessed by file system commands (e.g., “ls” or “ls—a”, etc.). The container might optionally include an operating system 778, however such an operating system need not be provided. Instead, a container can include a runnable instance 758, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 776. Such a container virtual disk controller can perform any of the functions that the aforementioned CVM virtual disk controller 726 can perform, yet such a container virtual disk controller does not rely on a hypervisor or any particular operating system so as to perform its range of functions.

In some environments multiple containers can be collocated and/or share one or more context. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
identifying a first time window and a second time window for processing tasks in a cluster of nodes, the first time window has a higher resource usage rate for a foreground task than the second time window, wherein a user virtual machine executes the foreground task and a control virtual machine executes a background task, the control virtual machine executes the background task to manage a storage resource accessed by the user virtual machine for the foreground task; and
scheduling the background task for execution by the control virtual machine at a lower resource usage rate during the first time window than during the second time window.

2. The method of claim 1, further comprising receiving a time window description composed of successive time segments.

3. The method of claim 1, wherein a time window description comprises at least one recurring periodic specification.

4. The method of claim 1, wherein a time window description is described using a graphical user interface.

5. The method of claim 1, wherein a time window description is described using a command line interface.

6. The method of claim 1, further comprising observing an aggregate CPU utilization, an aggregate memory utilization, and aggregate storage I/O rates on the cluster of nodes to determine a seasonality period of utilization.

7. The method of claim 1, wherein the background tasks perform at least one aspect of, storage reclamation, or storage compaction, or storage deduplication, or storage replication, or disk balancing, or data transformation, or storage layout changes, or any combination thereto.

8. The method of claim 1, wherein the first time window and the second time window corresponds a throttling level defined in a set of policies.

9. A non-transitory computer readable medium having stored thereon a sequence of instructions which, when executed by a processor performs a set of acts, the set of acts comprising:
identifying a first time window and a second time window for processing tasks in a cluster of nodes, the first time window has a higher resource usage rate for a foreground task than the second time window, wherein a user virtual machine executes the foreground task and a control virtual machine executes a background task, the control virtual machine executes the background task to manage a storage resource accessed by the user virtual machine for the foreground task; and
scheduling the background task for execution by the control virtual machine at a lower resource usage rate during the first time window than during the second time window.

10. The computer readable medium of claim 9, the set of acts further comprising receiving a time window description composed of successive time segments.

11. The computer readable medium of claim 9, wherein a time window description comprises at least one recurring periodic specification.

12. The computer readable medium of claim 9, the set of acts further comprising observing an aggregate CPU utilization, an aggregate memory utilization, and aggregate storage I/O rates on the cluster of nodes to determine a seasonality period of utilization.

13. The computer readable medium of claim 9, wherein the background tasks perform at least one aspect of, storage reclamation, or storage compaction, or storage deduplication, or storage replication, or disk balancing, or data transformation, or storage layout changes, or any combination thereto.

14. The computer readable medium of claim 9, wherein a time window description is described using a user interface is at least one of, a graphical user interface, or a command line interface, or any combination thereto.

15. A system comprising:
a storage medium having stored thereon a sequence of instructions; and
a processor that executes the sequence of instructions to perform a set of acts, the set of acts comprising:
identifying a first time window and a second time window for processing tasks in a cluster of nodes, the first time window has a higher resource usage rate for a foreground task than the second time window, wherein a user virtual machine executes the foreground task and a control virtual machine executes a background task, the control virtual machine executes the background task to manage a storage resource accessed by the user virtual machine for the foreground task; and
scheduling the background task for execution by the control virtual machine at a lower resource usage rate during the first time window than during the second time window.

16. The system of claim 15, further comprising receiving a time window description composed of successive time segments.

17. The system of claim 15, wherein a time window description comprises at least one recurring periodic specification.

18. The system of claim 15, wherein a time window description is described using a web interface.

19. The system of claim 15, wherein a time window description is described using textual interface.

20. The system of claim 15, wherein the background tasks perform at least one aspect of, storage reclamation, or storage compaction, or storage deduplication, or storage replication, or disk balancing, or data transformation, or storage layout changes, or any combination thereto.
